(19) United States
(12) Patent Application Publication
(10) Pub. No.: US 2026/0077682 A1
(43) Pub. Date: Mar. 19, 2026

(54) ELECTRIC VEHICLE SYSTEM TO REDUCE VIBRATION

(71) Applicant: FCA US LLC, Auburn Hills, MI (US)

(72) Inventor: Ramakanth Maddali, Auburn Hills, MI (US)

(21) Appl. No.: 18/887,541

(22) Filed: Sep. 17, 2024

(51) Int. Cl. B60L 58/26

(52) U.S. Cl. CPC B60L 58/26; B60L 2270/145

(57) ABSTRACT

An electrified vehicle includes an electrified powertrain including a battery system configured to power an electric traction motor to generate drive torque, a frame supporting the electric traction motor, a steering wheel, and a thermal system configured to provide cooling to the electrified vehicle. The thermal system includes a coolant loop with an electric compressor. The electric traction motor includes roll, pitch, and yaw rotational modes corresponding to an X-Y-Z coordinate system. The electric compressor is configured to generate axial force in an axial direction and radial forces in a radial direction. The electric compressor is coupled to the electric traction motor such that the axial direction is aligned with the Z-axis that corresponds to the yaw rotational mode to thereby excite the yaw rotational mode of the electric traction motor, which reduces vibrational output to the steering wheel.

### FIELD

The present application relates generally to electrified vehicles and, more particularly, to electrified vehicles with an electric compressor arrangement to reduce vibration.

### BACKGROUND

In traditional internal combustion engine driven vehicles, an air conditioning (A/C) compressor is typically mounted to the engine and driven by a belt. Any vibration caused by the compressor and transferred to the steering wheel is often masked by the vibrations caused by operation of the engine. In electric vehicles (EVs), the A/C compressor is typically attached to the electric drive motor through a plurality of non-elastomeric mounts. During compressor operation, generated forces may excite the electric motor's roll and pitch modes, which in turn may cause vibrations at the steering wheel. However, in the absence of masking engine vibrations, the vibrations caused by the compressor at the steering wheel may be noticeable to the driver. Thus, while such conventional systems work well for their intended purpose, it is desirable to provide continuous improvement in the relevant art.

### SUMMARY

In accordance with one example aspect of the invention, an electrified vehicle is provided. In one example implementation, the electrified vehicle includes an electrified powertrain including a battery system configured to power an electric traction motor to generate drive torque, a frame supporting the electric traction motor, a steering wheel, and a thermal system configured to provide cooling to the electrified vehicle. The thermal system includes a coolant loop with an electric compressor. The electric traction motor includes roll, pitch, and yaw rotational modes corresponding to an X-Y-Z coordinate system. The electric compressor is configured to generate axial force in an axial direction and radial forces in a radial direction. The electric compressor is coupled to the electric traction motor such that the axial direction is aligned with the Z-axis that corresponds to the yaw rotational mode to thereby excite the yaw rotational mode of the electric traction motor, which reduces vibrational output to the steering wheel.

In addition to the foregoing, the described electrified vehicle may include one or more of the following features: wherein the electric compressor is located such that a center of gravity (COG) of the electric compressor has the same Z- and Y-coordinates as a COG of the electric traction motor; wherein an orientation of the electric compressor relative to the electric traction motor does not excite the roll and pitch rotational modes of the electric traction motor; and wherein the electric compressor includes a compressor scroll configured to rotate about the axial direction.

In addition to the foregoing, the described electrified vehicle may include one or more of the following features: wherein the radial forces generated by the electric compressor are greater than the axial forces generated by the electric compressor; wherein the electric compressor is coupled to the electric traction motor via one or more non-elastomeric mounts; wherein the electric traction motor is coupled to the frame via one or more elastomeric mounts or hydraulic mounts; wherein the coolant loop further includes a condenser, an expansion device, and an evaporator, and wherein the electric compressor is configured to compress a refrigerant; and wherein the electrified vehicle is absent of an internal combustion engine.

In accordance with another example aspect of the invention, a method of assembling an electrified vehicle to reduce steering wheel vibrations is provided. In one example, the method includes providing a frame, coupling an electric traction motor to the frame, wherein the electric traction motor includes roll, pitch, and yaw rotational modes corresponding to an X-Y-Z coordinate system, providing an electric compressor configured to generate axial force in an axial direction and radial forces in a radial direction, and coupling the electric compressor to the electric traction motor such that the axial direction is aligned with the Z-axis that corresponds to the yaw rotational mode to thereby excite the yaw rotational mode of the electric traction motor, which reduces vibrational output to a steering wheel.

In addition to the foregoing, the described method may include one or more of the following features: locating the electric compressor such that a center of gravity (COG) of the electric compressor has the same Z- and Y-coordinates as a COG of the electric traction motor; wherein an orientation of the electric compressor relative to the electric traction motor does not excite the roll and pitch rotational modes of the electric traction motor; wherein the electric compressor includes a compressor scroll configured to rotate about the axial direction; and wherein the radial forces generated by the electric compressor are greater than the axial forces generated by the electric compressor.

In addition to the foregoing, the described method may include one or more of the following features: coupling the electric compressor to the electric traction motor via one or more non-elastomeric mounts; coupling the electric traction motor to the frame via one or more elastomeric mounts or hydraulic mounts; providing the compressor as part of a thermal system coolant loop that includes a condenser, an expansion device, and an evaporator, wherein the electric compressor is configured to compress a refrigerant; and wherein the electrified vehicle is absent of an internal combustion engine.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a block diagram of an example electrified vehicle in accordance with the principles of the present application;

FIG. 2 is a schematic diagram of the electrified vehicle of FIG. 1, in accordance with the principles of the present application;

FIG. 3 illustrates an example electric traction motor of the electrified vehicle of FIG. 1 with an X-Y-Z coordinate system corresponding to roll, pitch, and yaw rotational modes of the electric traction motor, in accordance with the principles of the present application;

FIG. 4 illustrates an example electric compressor of the electrified vehicle of claim 1 with axial and radial force directions, in accordance with the principles of the present application;

FIG. 5 illustrates an example electric compressor of the electrified vehicle of claim 1 with axial and radial force directions, in accordance with the principles of the present application;

FIG. 6 illustrates tables of example X, Y, Z coordinates and rotational mode frequencies of the electric motor, in accordance with the principles of the present application;

FIG. 7 is a graph illustrating example vibration levels at the steering wheel due to unit torque at the electric motor, in accordance with the principles of the present application;

FIG. 8 is a graph illustrating example compressor generated forces versus frequency, in accordance with the principles of the present application;

FIG. 9 is a schematic side view of the electric compressor and electric motor of the electric vehicle of FIG. 1, in accordance with the principles of the present application;

FIG. 10 is another schematic side view of the electric compressor and electric motor of the electric vehicle of FIG. 1, in accordance with the principles of the present application; and

FIG. 11 is a flow diagram of an example method of assembling the electric vehicle of FIG. 1, in accordance with the principles of the present application.

### DESCRIPTION

As previously mentioned, in the absence of an internal combustion engine to produce masking vibrations, an electrified vehicle (e.g., BEV) with a motor mounted A/C compressor may cause noticeable vibration at the vehicle steering wheel. Accordingly, the systems and methods described herein are configured to reduce vibration at the steering wheel caused by operation of the A/C compressor. In one example, steering wheel vibrations are lower when the yaw mode of the electric motor is excited compared to the excitation of the roll and pitch modes of the electric motor. In the example system, the compressor is oriented and located on the electric motor such that the larger components of the compressor forces primarily excite the electric motor's yaw mode alone, while the roll and pitch modes are minimally excited, thereby reducing steering wheel vibrations.

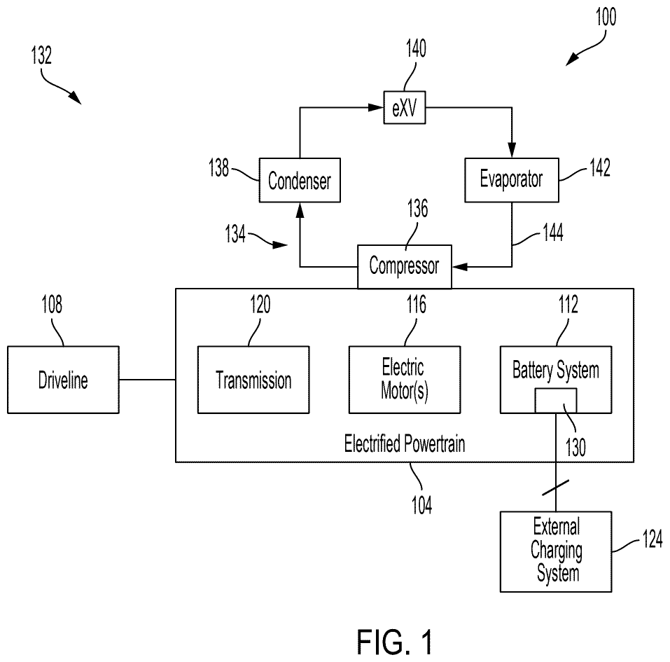

Referring now to FIG. 1, a functional block diagram of an example electrified vehicle 100 (also referred to herein as “vehicle 100”) is illustrated. The vehicle 100 includes an electrified powertrain 104 configured to generate and transfer drive torque to a driveline 108 of the vehicle 100 for propulsion. The electrified powertrain 104 generally comprises a high voltage (HV) battery system 112, one or more electric traction motors 116, and a gear box or transmission 120. The battery system 112 is selectively connectable (e.g., by the driver) to an external charging system 124 for charging of the battery system 112. The battery system 112 includes at least one battery pack assembly 130.

In the example embodiment, the vehicle 100 also includes a thermal system 132 that generally includes an HVAC circuit or loop 134. Although not shown, the thermal system 132 can also include a battery system coolant loop to heat/cool HV battery system 112, as well as a low temperature coolant loop for heating/cooling various components of the vehicle such as power electronics including an integrated dual charging module (IDCM), a power inverter module (PIM), and the one or more electric motors 116. The HVAC loop 134 is a standard vehicle air conditioning system that generally includes a compressor 136 (e.g., electric A/C compressor-EAC), a condenser 138, an expansion device 140, and an evaporator 142. The compressor 136 is coupled to the electric motor 116, as will be described herein in more detail.

In operation, a suction line 144 provides gaseous coolant (e.g., refrigerant) to compressor 136, which subsequently compresses the refrigerant. The compressed and heated refrigerant is then directed to the condenser 138 where the heat from compression is dissipated and the refrigerant condenses to a liquid. The liquid refrigerant is then directed to the expansion device 140 (e.g., a thermal expansion valve) where it is reduced in pressure and at least partially vaporized, thereby reducing the temperature of the refrigerant. The cooled refrigerant is then supplied to evaporator 142, where it is evaporated to provide cooling to the vehicle cabin. The resulting gaseous, warmed refrigerant is then returned to the compressor 136 via the suction line 144 and the cycle is repeated.

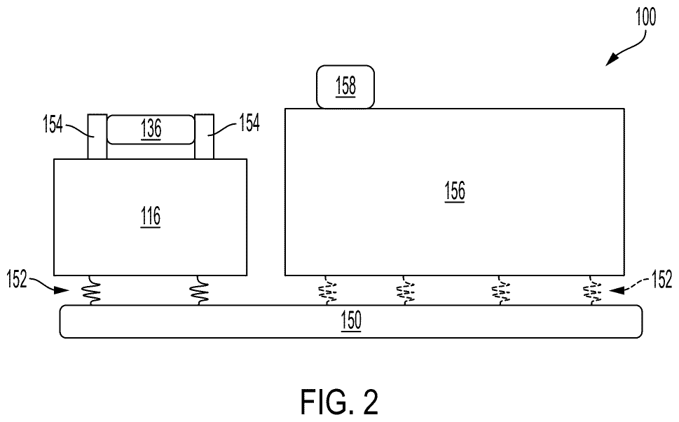

Referring now to FIG. 2, a schematic diagram of vehicle 100 is illustrated. In the example embodiment, the electric motor 116 is mounted to a chassis or frame 150 through a plurality of mounts 152 (e.g., elastomeric or hydraulic mounts). The compressor 136 is coupled to the electric motor 116 via non-elastomeric fasteners 154. A vehicle body 156 is also mounted to the frame 150 through elastomeric mounts 152. The vehicle body 156 supports a steering wheel 158 via a steering column (not shown). As previously described, operation of the compressor 136 may generate vibrations, which are transferred through the electric motor 116, frame 150, and body 156 to the steering wheel 158. It is desirable to reduce or prevent such vibrations (e.g., NVH) from being transferred to the steering wheel 158 where they may be perceived by the driver.

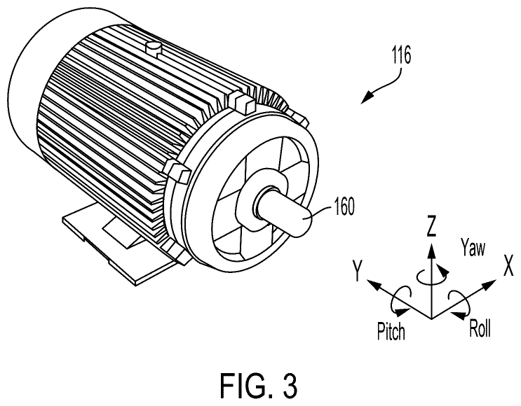

Referring now to FIG. 3, an example electric traction motor 116 is illustrated with a rotor output shaft 160 configured to rotate about an axis (Y-axis). The electric traction motor 116 is shown arranged on an X-Y-Z coordinate system where the X-axis corresponds to a roll rotational mode, the Y-axis corresponds to a pitch rotational mode, and the Z-axis corresponds to a yaw rotational mode. In one example, the electric motor 116 is arranged on the frame 150 such that the Y-axis is generally in a cross-car direction. As such, the mounting arrangement of electric motor 116 leads to six rigid modes, as shown below in Table 1. Modes four to six are referred to as rotational rigid body modes.

TABLE 1

| | Electric Motor Rigid Body Mode Listing |
|---|---|
| Mode 1 | Electric motor translates along X axis (F/A mode) |
| Mode 2 | Electric motor translates along Y axis (Lateral mode) |
| Mode 3 | Electric motor translates along Z axis (Bounce mode) |
| Mode 4 | Electric motor rotates about X axis (Pitch mode) |
| Mode 5 | Electric motor rotates about Y axis (Roll mode) |
| Mode 6 | Electric motor rotates about Z axis (Yaw mode) |

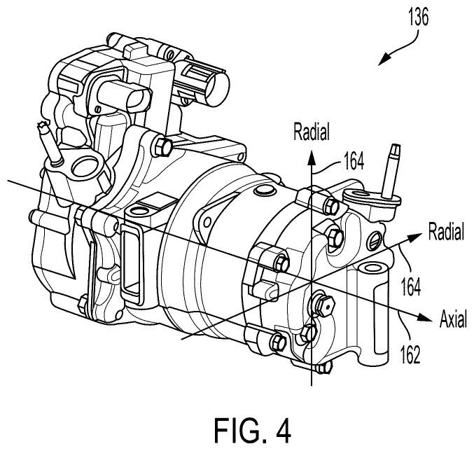

FIG. 4 illustrates an example compressor 136 having a compressor scroll (not shown) configured to rotate about an axial axis 162 that is perpendicular to radial axes 164. During operation, the compressor 136 generates forces in both axial and radial direction. These forces may excite the roll and pitch modes of the electric motor 116, thereby causing vibrations in the steering wheel 158. The steering wheel vibrations are higher when the roll and pitch rigid body modes of the electric motor 116 are excited as compared to the vibrations due to yaw mode alone. In the example embodiment, the stiffness of the elastomeric mounts 152 is tuned or adjusted such that the electric motor rigid body modes are decoupled. For example, if the yaw mode of the electric motor 116 is excited by a torque at its center of gravity about the Z-axis, the electric motor 116 largely exhibits a pure rotational vibration about the Z-axis with no or minimal vibration in the other axes. Also, the yaw mode of the electric motor is not excited (or only minimally excited) by torques about X and Y axes.

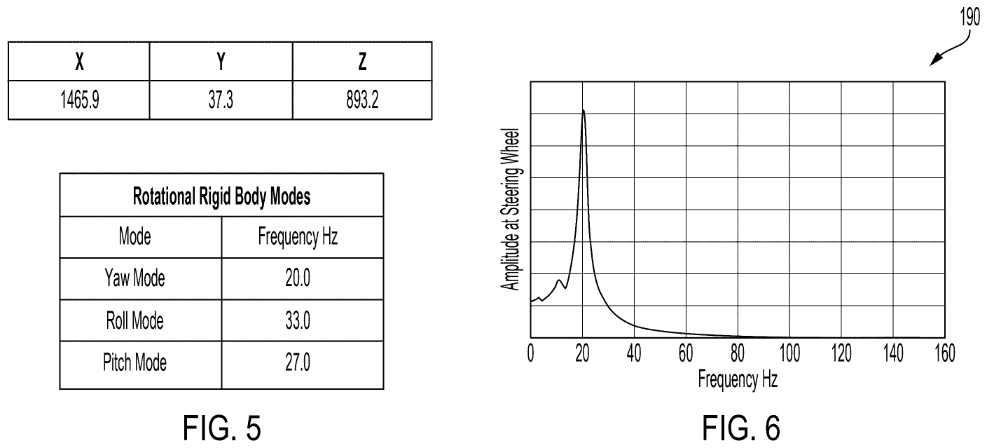

As shown in FIG. 5, in one example embodiment, to determine the location and orientation of compressor 136 to reduce steering wheel vibrations, the center of gravity of the electric motor 116 is first determined. For example, on the X, Y, Z coordinate system, the electric motor center of gravity is located at X=1465.9 mm, Y=37.3 mm, and Z=893.2 mm. Next, the rotational rigid body of the electric motor 116 are determined. In the illustrated example, the yaw mode has a frequency of 20.0 Hz, the roll mode has a frequency of 33.0 Hz, and the pitch mode has a frequency of 27.0 Hz.

FIG. 6 illustrates an example plot 190 of the response due to applying unit torque to the electric motor center of gravity. The response (curve) captures the angular displacement (degrees) at the electric motor center of gravity about the Z-axis. The curve indicates one major peak alone—that of yaw mode of the electric motor at 20.0 Hz and minimal effect/influence of the roll and pitch modes.

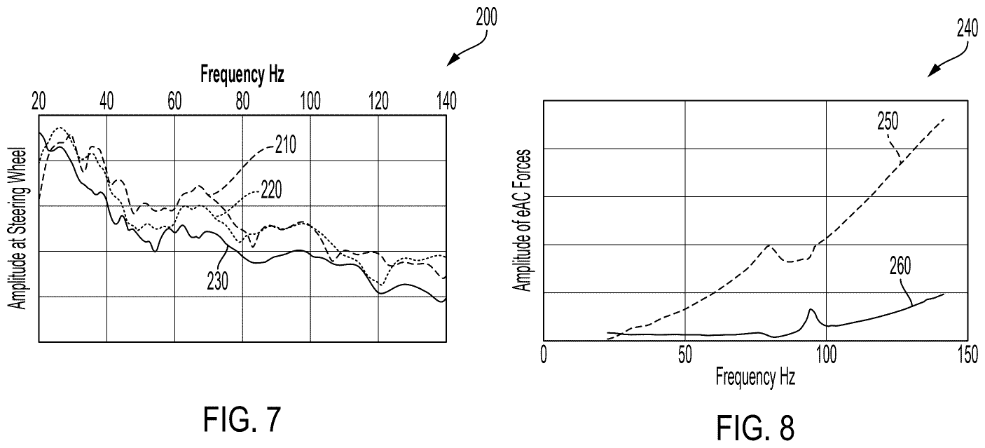

FIG. 7 illustrates a graph 200 of example vibration levels at the steering wheel 158 due to unit torque at the electric motor 116. Line 210 corresponds to steering wheel vibration amplitudes due to excitation of the roll mode of the electric motor 116 by a torque about the Y-axis. Line 220 corresponds to steering wheel vibration amplitudes due to excitation of the pitch mode of the electric motor 116 by a torque about the X-axis. Line 230 corresponds to steering wheel vibration amplitudes due to excitation of the yaw mode of the electric motor 116 by a torque about the Z-axis. As illustrated, steering wheel vibration amplitudes are higher when the roll mode and pitch mode are excited when compared to vibration amplitudes due to yaw mode excitation.

FIG. 8 illustrates a graph 240 of example compressor generated forces (amplitude) versus frequency. Forces in all three plots are normalized for scale. In operation, the compressor 136 generates larger radial forces than axial force. Line 250 corresponds to amplitude of radial forces generated by the compressor 136, and line 260 corresponds to amplitude of axial forces generated by the compressor 136. Accordingly, to reduce steering wheel vibrations, the compressor 136 is located and oriented on the electric motor 116 such that (i) the larger force components of the compressor only (or substantially) excite the yaw mode of the electric motor 116, (ii) the roll and pitch modes of the electric motor are not excited (or minimally excited), and (iii) the effective moment about the Z-axis that excites the yaw mode is at a minimum.

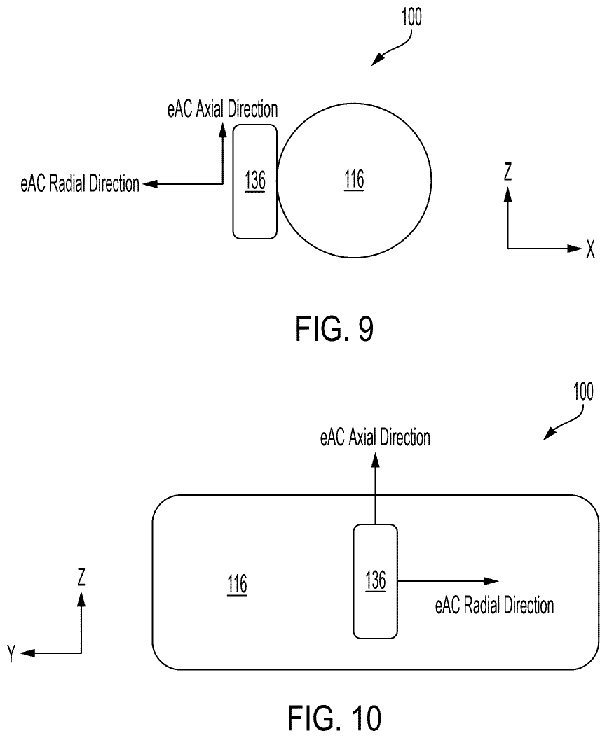

With reference now to FIGS. 9 and 10, an example configuration of electric motor 116 and compressor 136 to reduce steering wheel vibration is provided. In the example embodiment, compressor 136 is oriented and located such that (i) the compressor axial direction is located along the electric motor Z-axis (yaw axis), and (ii) the compressor center of gravity and the electric motor center of gravity have the same Z- and Y-coordinates. In this way, the largest force component of the compressor (the radial component) creates a moment or torque about the Z-axis of the electric motor 116 and mainly excites the yaw rotational mode of the electric motor 116. Also, the effective moment about the Z-axis at the electric motor center of gravity, which excites the yaw mode, is lowest. The smallest force component of the compressor (the axial component) excites the roll mode of the electric motor 116 (about Y-axis), and the pitch mode of the electric motor (X-axis) is not excited or only minimally excited.

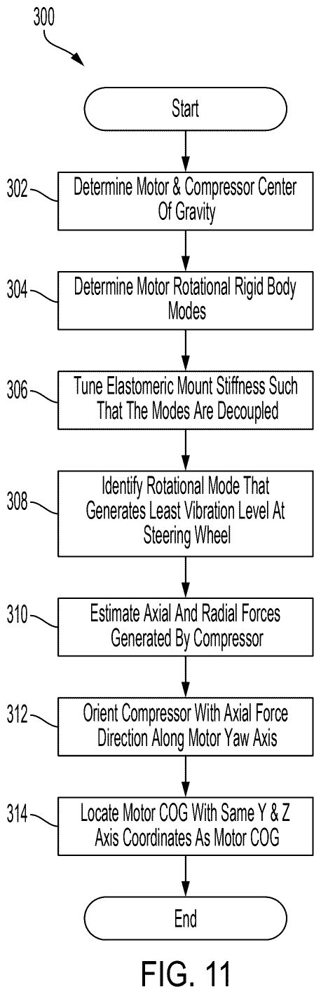

Referring now to FIG. 11, a flow diagram of an example manufacturing/assembly method 300 of coupling A/C compressor 136 to electric traction motor 116 to reduce vibrations at steering wheel 158 is provided. While the components of vehicle 100 and FIG. 1 are referenced for explanatory purposes, it will be appreciated that this method 300 could be applicable to any suitable vehicle. Moreover, one or more of the method steps may be performed by a controller (not shown). The method begins at 302 by determining a center of gravity (COG) of the electric motor 116 and the compressor 136. At 304, the rotational rigid body modes of the electric motor 116 are determined. In this way, the roll, pitch, and yaw rotational modes (X-Y-Z coordinates) of electric motor 116 are determined/identified.

At 306, the elastomeric mount stiffness is tuned such that the modes are decoupled. At 308, the rotational rigid body mode of the electric motor 116 that generates the least vibration level at the steering wheel 158 is determined/identified. At 310, the axial and radial forces generated by the compressor 136 during operation are estimated/determined. At 312, the compressor 136 is oriented with the compressor axial force direction aligned with the rotational rigid body mode of the electric motor that generates the least vibration level (e.g., aligned with the yaw axis). At 314, the compressor 136 is coupled to the electric motor 116 such that the compressor COG is located with the same Y and Z coordinates as the motor COG.

It will be appreciated that the term “controller” or “module” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present disclosure, its application or uses. Thus, variations that do not depart from the gist of the present disclosure are intended to be within the scope of the present disclosure.

What is claimed is:

1. An electrified vehicle comprising:
an electrified powertrain including a battery system configured to power an electric traction motor to generate drive torque;
a frame supporting the electric traction motor;
a steering wheel; and
a thermal system configured to provide cooling to the electrified vehicle, the thermal system including a coolant loop with an electric compressor,
wherein the electric traction motor includes roll, pitch, and yaw rotational modes corresponding to an X-Y-Z coordinate system,
wherein the electric compressor is configured to generate axial force in an axial direction and radial forces in a radial direction,
wherein the electric compressor is coupled to the electric traction motor such that the axial direction is aligned with the Z-axis that corresponds to the yaw rotational mode to thereby excite the yaw rotational mode of the electric traction motor, which reduces vibrational output to the steering wheel.

2. The electrified vehicle of claim 1, wherein the electric compressor is located such that a center of gravity (COG) of the electric compressor has the same Z- and Y-coordinates as a COG of the electric traction motor.

3. The electrified vehicle of claim 1, wherein an orientation of the electric compressor relative to the electric traction motor does not excite the roll and pitch rotational modes of the electric traction motor.

4. The electrified vehicle of claim 1, wherein the electric compressor includes a compressor scroll configured to rotate about the axial direction.

5. The electrified vehicle of claim 1, wherein the radial forces generated by the electric compressor are greater than the axial forces generated by the electric compressor.

6. The electrified vehicle of claim 1, wherein the electric compressor is coupled to the electric traction motor via one or more non-elastomeric mounts.

7. The electrified vehicle of claim 6, wherein the electric traction motor is coupled to the frame via one or more elastomeric mounts or hydraulic mounts.

8. The electrified vehicle of claim 1, wherein the coolant loop further includes a condenser, an expansion device, and an evaporator, and wherein the electric compressor is configured to compress a refrigerant.

9. The electrified vehicle of claim 1, wherein the electrified vehicle is absent of an internal combustion engine.

10. A method of assembling an electrified vehicle to reduce steering wheel vibrations, the method comprising:
providing a frame;
coupling an electric traction motor to the frame, wherein the electric traction motor includes roll, pitch, and yaw rotational modes corresponding to an X-Y-Z coordinate system;
providing an electric compressor configured to generate axial force in an axial direction and radial forces in a radial direction; and
coupling the electric compressor to the electric traction motor such that the axial direction is aligned with the Z-axis that corresponds to the yaw rotational mode to thereby excite the yaw rotational mode of the electric traction motor, which reduces vibrational output to a steering wheel.

11. The method of claim 10, further comprising locating the electric compressor such that a center of gravity (COG) of the electric compressor has the same Z- and Y-coordinates as a COG of the electric traction motor.

12. The method of claim 10, wherein an orientation of the electric compressor relative to the electric traction motor does not excite the roll and pitch rotational modes of the electric traction motor.

13. The method of claim 10, wherein the electric compressor includes a compressor scroll configured to rotate about the axial direction.

14. The method of claim 10, wherein the radial forces generated by the electric compressor are greater than the axial forces generated by the electric compressor.

15. The method of claim 10, further comprising coupling the electric compressor to the electric traction motor via one or more non-elastomeric mounts.

16. The method of claim 15, further comprising coupling the electric traction motor to the frame via one or more elastomeric mounts or hydraulic mounts.

17. The method of claim 10, further comprising providing the compressor as part of a thermal system coolant loop that includes a condenser, an expansion device, and an evaporator, wherein the electric compressor is configured to compress a refrigerant.

18. The method of claim 10, wherein the electrified vehicle is absent of an internal combustion engine.
